(19) United States
(12) Patent Application Publication
(10) Pub. No.: US 2012/0256900 A1
(43) Pub. Date: Oct. 11, 2012

(54) METHOD OF SPONTANEOUSLY ESTABLISHING AN ONLINE COMMUNITY

(76) Inventor: Rebecca A. Rodriguez, La Center, WA (US)

(21) Appl. No.: 13/074,391

(22) Filed: Mar. 29, 2011

Related U.S. Application Data
(60) Provisional application No. 61/318,949, filed on Mar. 30, 2010.

(51) Int. Cl. G06F 17/00

(52) U.S. Cl. 345/418

(57) ABSTRACT

The present invention relates to a system and method for spontaneously establishing an online community.

### CROSS-REFERENCE TO RELATED APPLICATIONS

This application claims the benefit of U.S. Provisional App. No. 61/318,949, filed Mar. 30, 2010.

### BACKGROUND OF THE INVENTION

The present invention relates to a system and method for spontaneously establishing an online community.

The Internet has become a major platform for exchanging goods and information including, by way of examples only, online shopping, online auctions, photo album sharing and social networking. A social network is a social structure made up of individuals and/or organizations which are connected by one or more specific types of interdependency. Typically, a user establishes an account with a social networking website that enables the user to list others to be included in the user's network. While social networking is individual centric, it is desired to provide an online system and method that enables persons have a common interest to spontaneously form a community for a specific purpose.

### BRIEF DESCRIPTION OF THE DRAWINGS

FIG. 1 is a block diagram of a computer system.

FIG. 2 illustrates an exemplary initial web page.

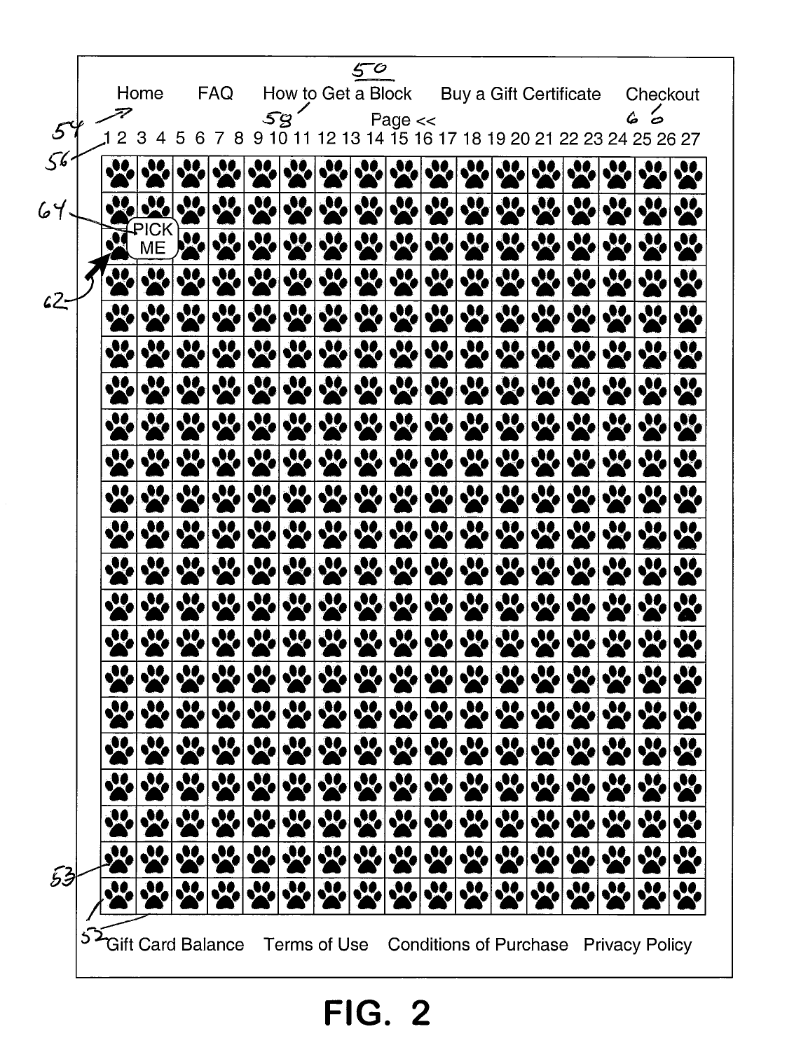

FIG. 3 illustrates an exemplary web page with blocks of purchase tiles.

FIG. 4 illustrates an exemplary web page displaying a first purchaser's message.

FIG. 5 illustrates an exemplary web page displaying a second purchaser's message.

FIG. 6 illustrates an exemplary block selection web page.

FIG. 7 illustrates an exemplary information input web page.

### DETAILED DESCRIPTION OF PREFERRED EMBODIMENTS

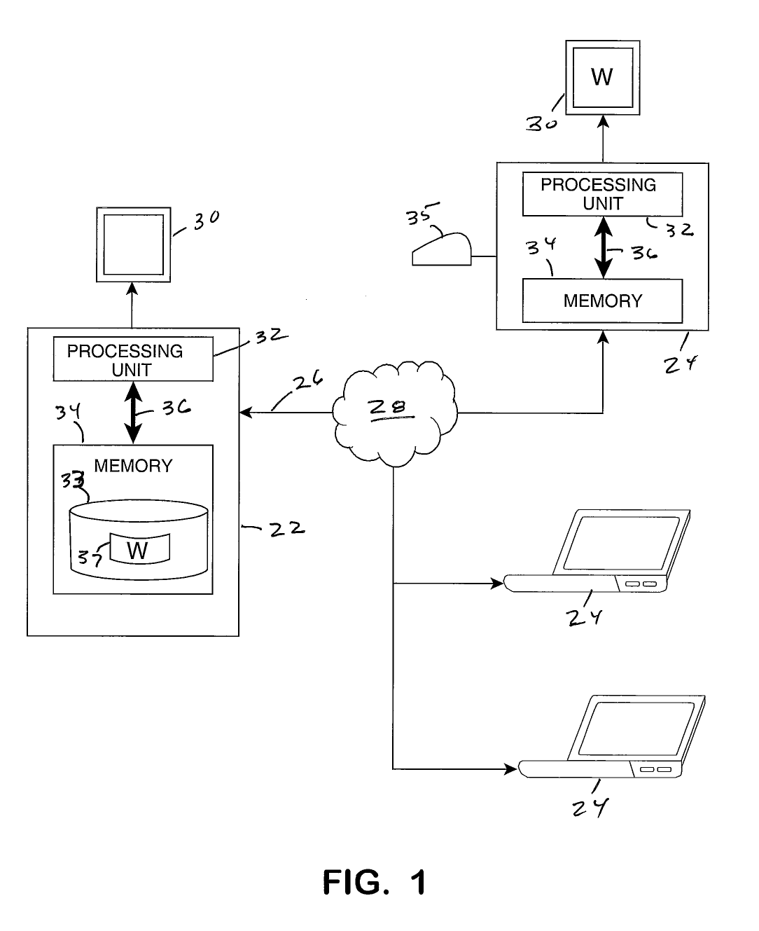

Referring in detail to the drawings where similar parts are identified by like reference numerals, and, more particularly to FIG. 1 an exemplary data processing system 20 for displaying content of potential interest to an online community comprises a server 22 which is arranged to communicate with a number of user terminals 24 over a communication network 26 which may include the Internet 28, a collection of interconnected communication systems. The server 22 may be a computer system and may control the operation of a website, W, that provides a service. The user terminals 24 may also be computer systems and like the server 22 may include one or more displays 30, a processing unit 32, memory devices 34, such as disk storage 33, and a system bus 36 communicatively connecting the various components of the respective computer. The website W comprises a data structure 37 that is stored on one of the memory devices and includes instructions controlling the processing unit to enable the operation of the website and its display at the user terminals.

Many projects which may be of interest to a substantial group of individuals require funding. The present inventor concluded that the sale or rental of portions of a website appealing to persons having a common interest could be used to spontaneously develop an online community and enable the community to fund a project of interest to the community. For example, a pet adoption project or a film about animals might be funded by sales to pet owners of online opportunities to publicize their pets and sales of advertising to businesses offering products and services of interest to pet owners.

The website, W, comprises a data structure 37 stored in the memory 34 of a server 22 and includes software enabling selective display of electronic documents or pages at a user's terminal 24. Referring to FIG. 1, the website comprises a plurality of pages including a plurality of viewing pages one of which may the home page or the first page displayed when the website is initially activated. The viewing pages, for example, viewing page 50, include an area that is divided into a plurality of tiles 52 or viewing pixels and also include a plurality of shortcuts individually selectable by the user to cause other pages of the website to be displayed at the user's terminal. To indicate that a tile is available for purchase, the tiles are initially represented by an icon 53. A first group of shortcuts 56 directs the server to display the ones of a plurality of similar viewing pages and a second group of shortcuts 54 causes the selective display of pages related to specific subjects of interest to the website's users. For example, when the shortcut HOW TO GET A BLOCK 58 is selected, the server will cause a page to be displayed that describes the process of purchasing or otherwise acquiring a right to a portion of viewing page corresponding to one or more tile(s) 52. Selecting CHECKOUT 60 causes the user's terminal to display a page and to execute software instructions enabling the user's payment of a fee for acquiring a right in the portion of the page represented the purchased tile(s).

Individual tiles 52 of the viewing pages are selectable by a user with a pointer 62 controlled by a mouse 35 or other pointing device at the user's terminal 24. Moving the pointer over a tile (mouse over) may cause a message 64 to be displayed regarding the tile. For example, if an icon is displayed for the tile, the message may urge the user to purchase that tile.

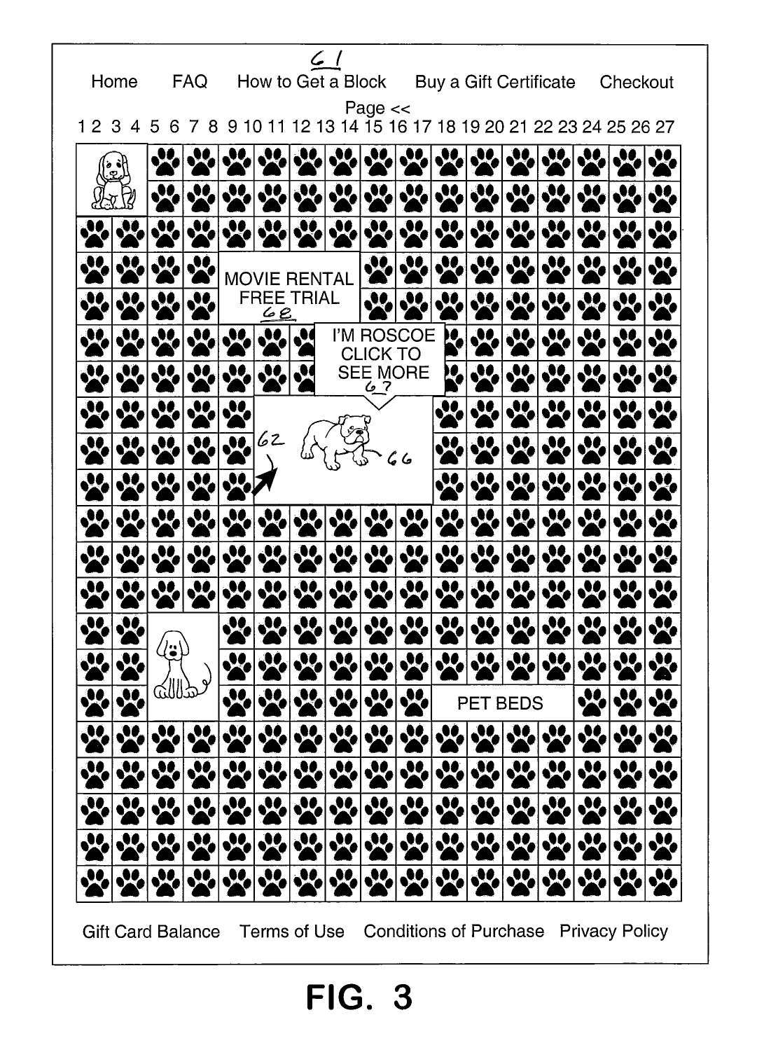

By selecting a tile, the user is offered the opportunity to “purchase” a block of tiles contiguous to the selected tile. By purchasing a block of tiles, the user obtains the right to choose what the server will display at the portion of the page represented by the block of tiles. Referring to FIG. 3, for a website related to pet ownership a user's purchase of a block of tiles might enable the user to display in the portion of a page, for example, page 61, represented by the block of tiles a photograph of the user's pet 66 or an advertisement or other message 68 of potential interest to pet owners. When a tile is occupied by an image provided by the purchaser, a second message 67 may be displayed when a user causes the pointer to collocate with the block of purchased tiles.

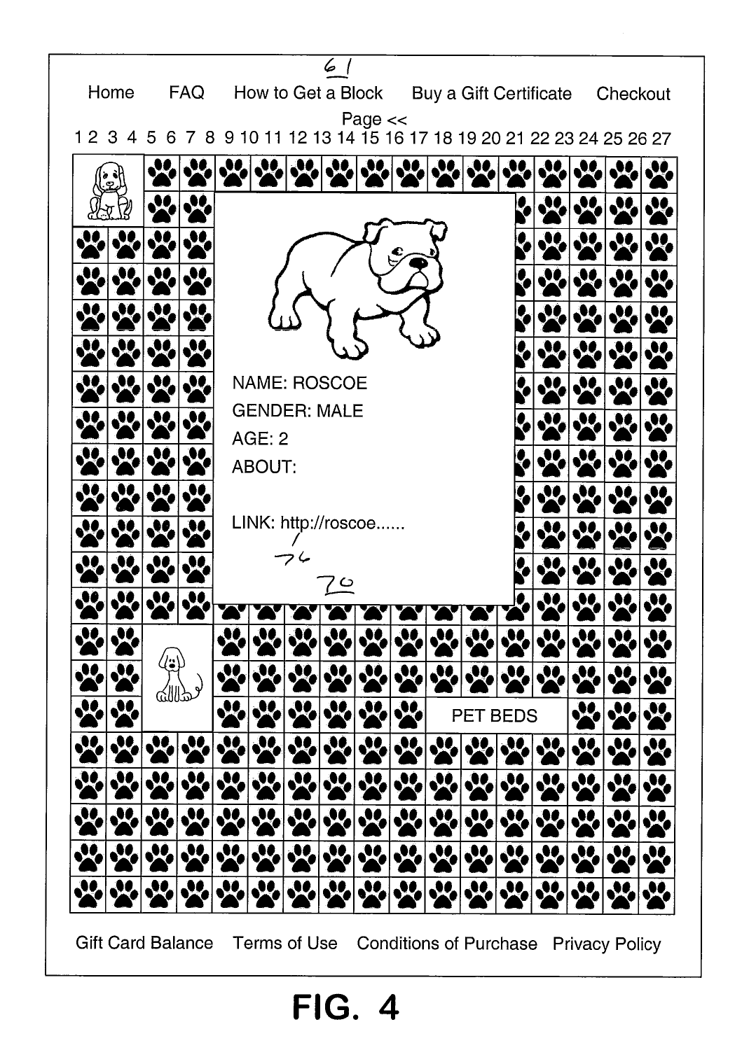

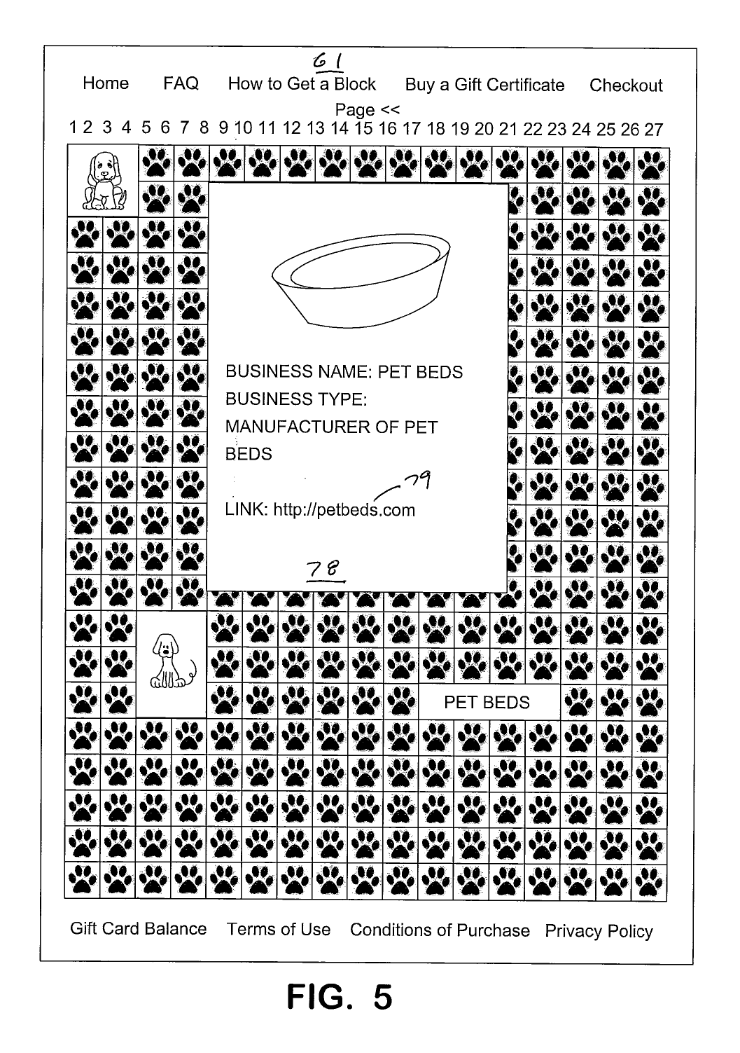

When the block of purchased tiles is selected, the server causes additional information about the image to be displayed. Referring to FIG. 4, for example, when a block of tiles displaying a picture of a pet is selected, a window 70 opens in which a larger image of the pet and additional information about the pet, such as the pet's name and age and a hyperlink to a website 76, can be displayed. Similarly, referring to FIG. 5, selecting a block including an advertisement 65 or other message, activates the display of a window 78 in which a further description of the advertised product or service is displayed. The description may contain a hyperlink 79 to the advertiser's website. The website provides a platform for the spontaneous development of a community of users having a common interest.

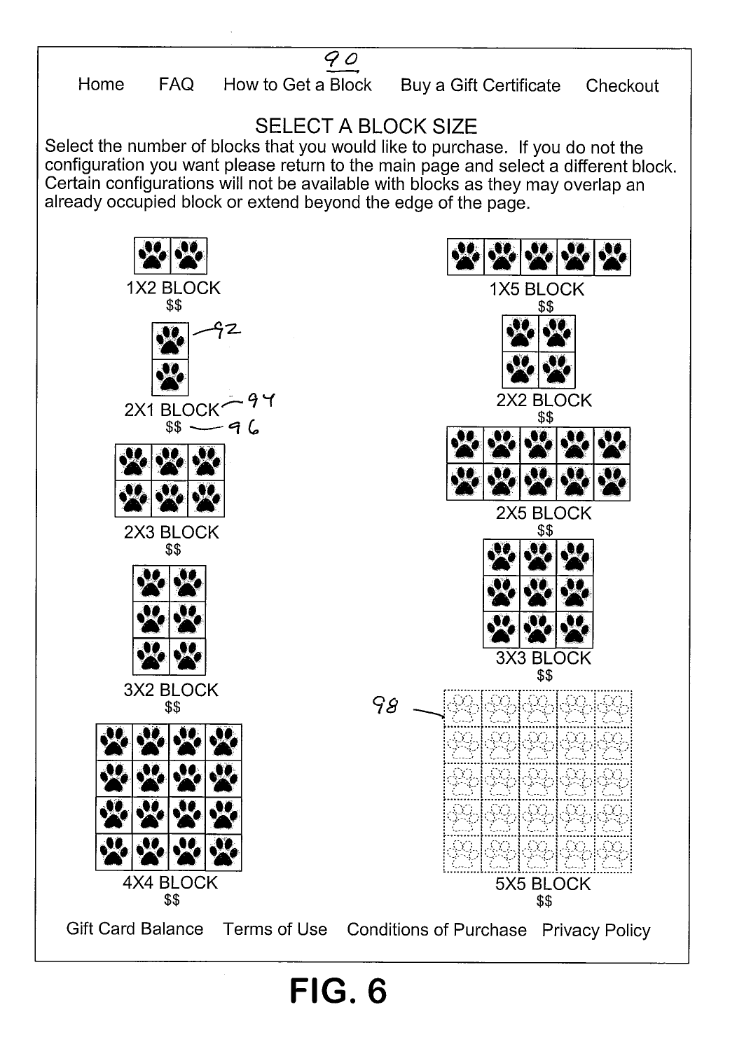

To “purchase” or otherwise obtain rights to a portion of a webpage, the user collocates the pointer 62 with a tile displaying an icon 53 and selects the tile by operation of the controls of the mouse or other device used to control the pointer. Referring to FIG. 6, selection of a tile causes the server to display a page with instructions related to the process of purchasing a block of tiles and enabling the user to select a block of contiguous tiles for purchase. When the user selects a tile on the viewing page, the server calculates the permissible arrangements of contiguous tiles that can be purchased without exceeding the page's boundary or encroaching on a tile that has already been purchased by another user. If a block of tiles contiguous to the tile selected by the user is available a graphical representation 92 of the block, a physical description 94 and a purchase price 96 are displayed. If a block of tiles is unavailable because it would exceed the page boundaries or encroach on another purchased tile, the server will cause that block(s) not to be displayed or to be grayed out indicating that the block is unavailable 98. The price of a block of tiles varies with the size of the block and can also vary with the location of the block and page on which the block appears. For example, the server may calculate a different price for a block located in the center of a page and a block located in a corner of the page or a different price for a block on the home page than on one of the pages other viewing pages of the web site.

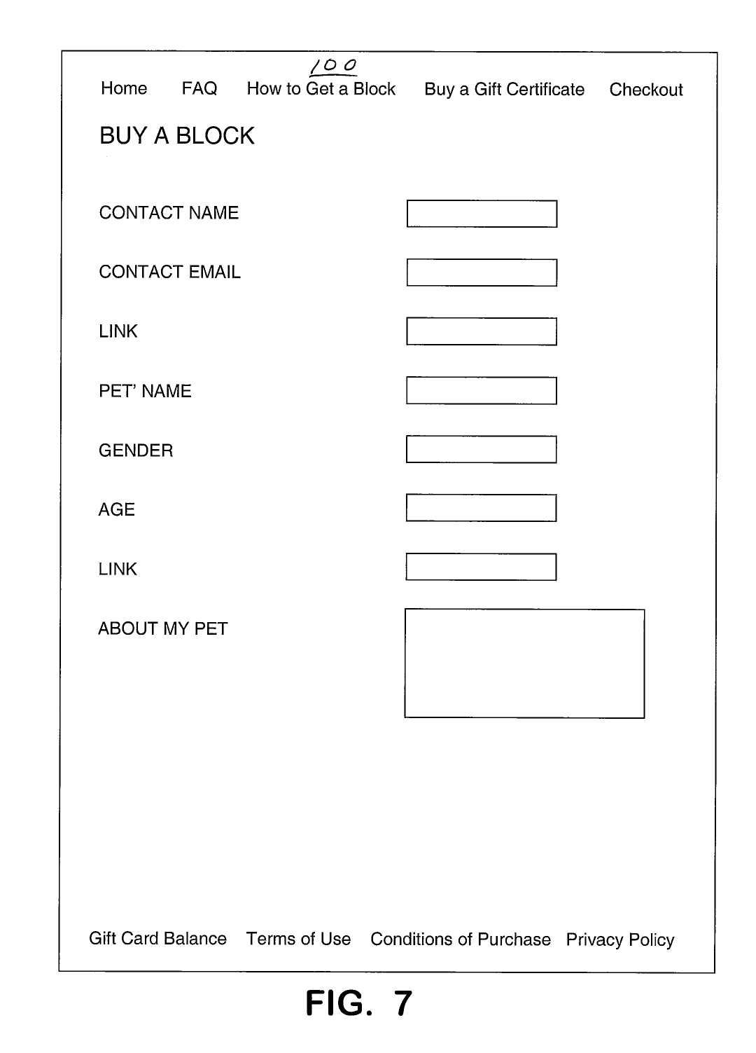

Referring to FIG. 7, when the user selects a block to purchase, the server causes an information page 100 to be displayed enabling the purchaser to upload to the server information and an image to be displayed by the user terminal in place of the purchased block of tiles. For example, for a website promoting a community of pet owners the information page might include the name of the owner, the pet's name, gender and age, and other information about the pet that might be of interest to other members of the community. When the user has completed the information page the server navigates to a CHECKOUT PAGE enabling the user to complete the purchase of the block of tiles and upload the information for display on the website.

A website offering a user an opportunity to purchase the right to display information on the website related a common interest provides an incentive for persons with a common interest to spontaneously form a community and provides a way of obtaining funding for a project or activity of interest to the community.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

1. A method for displaying content with a computer, said method comprising the steps of:
(a) displaying with a computer a first image comprising a plurality of user selectable areas;
(b) offering to display content provided by a user in an area of said first image selected by a user; and
(c) displaying a second image provided by said user in said area of said first image selected by said user.

2. The method for displaying content with a computer of claim 1 further comprising the step of displaying at least one of said second image, another image, text, video, audio and a hyperlink if said area of said first image selected by said user is selected by a viewer of said first image.

3. The method for displaying content with a computer of claim 1 wherein the step of offering to display content provided by said user in an area of said first selected by said user comprises the step of offering to display said content in a plurality of contiguous user selectable areas of said first image.
